(19) United States
(12) Patent Application Publication
(10) Pub. No.: US 2024/0055916 A1
(43) Pub. Date: Feb. 15, 2024

(54) WOUND-FIELD SYNCHRONOUS MACHINES AND CONTROL

(71) Applicants: Philip KORTA, Troy, MI (US); Lakshmi Varaha IYER, Troy, MI (US); Gerd SCHLAGER, Sankt Valentin (AT); MAGNA INTERNATIONAL INC., Aurora (CA)

(72) Inventors: Philip KORTA, Troy, MI (US); Lakshmi Varaha IYER, Troy, MI (US); Gerd SCHLAGER, Sankt Valentin (AT)

(21) Appl. No.: 17/766,291

(22) PCT Filed: Oct. 2, 2020
(86) PCT No.: PCT/US2020/053963

§ 371 Date: Apr. 4, 2022

Related U.S. Application Data
(60) Provisional application No. 62/909,882, filed on Oct. 3, 2019.
(60) Provisional application No. 62/924,840, filed on Oct. 23, 2019.

(51) Int. Cl. H02K 1/24; H02K 1/22

(52) U.S. Cl. CPC H02K 1/24; H02K 1/223

(57) ABSTRACT

A rotor for a wound-field synchronous machine (WFSM) comprises a core having a base with a ring-shaped cross-section extending between an outside surface and an inside surface defining a bore. The rotor also comprises a plurality of field windings spaced apart from one another at regular angular intervals and each extending around the base of the core, adjacent the outside surface and through the bore. Rotor field windings having radial, or spoke configurations are provided. Rotor field windings having V-shaped arrangements, in which two field windings each contribute to the production of each pole, are also provided. Rotors having permanent magnets in addition to field windings are also provided.

### CROSS-REFERENCE TO RELATED APPLICATIONS

This PCT International Patent application claims the benefit of and priority to U.S. Provisional Patent Application Ser. No. 62/909,882 filed on Oct. 3, 2019, and titled “Wound-Field Synchronous Machines And Control” and U.S. Provisional Patent Application Ser. No. 62/924,840 filed on Oct. 23, 2019, and titled “Wound-Field Synchronous Machines And Control,” the entire disclosures of which are hereby incorporated by reference.

### BACKGROUND

Wound-field synchronous machines (WFSMs) are electric machines, which can be used as motors, generators, or motor/generators, having one or more rotors with electromagnetic field windings configured to produce an induced magnetic field by passing electrical current therethrough. WFSMs present many potential advantages over permanent magnet and induction machines in common use for a variety of different applications.

### SUMMARY

A rotor for an electric machine is provided in some embodiments of the present disclosure. The rotor comprises a core having a base with a ring-shaped cross-section extending between an outside surface and an inside surface defining a bore. The rotor also comprises a plurality of field windings spaced apart from one another at regular angular intervals, with each of the field windings configured to conduct current in a radial direction around the base of the core to induce a magnetic field through the core tangentially to the ring-shaped cross-section.

In some embodiments, a rotor for an electric machine comprises a core having a base with a ring-shaped cross-section extending between an outside surface and an inside surface defining a bore, with the inside surface of the base defining an interior recesses. The rotor also includes an external coil retainer disposed upon the outside surface of the base, the external coil retainer circumferentially separated from the interior recess. A field winding extends radially and circumferentially from the interior recess around the base of the core and to the external coil retainer. The interior recess is one of a plurality of interior recesses spaced apart from one another at a regular angular interval.

In some embodiments, a rotor for an electric machine comprises a core having a base and a pole extending radially therefrom, and a field winding extending about the pole for generating an induced magnetic field therein. A permanent magnet is disposed within the pole.

A method of operating an electric machine is also provided. The method comprises conducting an electrical current through a field winding disposed around a pole to produce an induced magnetic field in the pole; and generating a permanent magnetic field in the pole with a permanent magnet.

### BRIEF DESCRIPTION OF THE DRAWINGS

Further details, features and advantages of designs of the invention result from the following description of embodiment examples in reference to the associated drawings.

FIG. 1 shows an end-view of a rotor for a conventional salient pole wound-field synchronous machine;

FIG. 2 shows an end-view of a rotor for a wound-field synchronous machine in accordance with the present disclosure;

FIG. 3 shows an end-view of a rotor for a wound-field synchronous machine in accordance with the present disclosure;

FIG. 4 shows an end-view of a rotor for a wound-field synchronous machine in accordance with the present disclosure;

FIG. 5 shows an end-view diagram of a rotor for a wound-field synchronous machine in accordance with the present disclosure;

FIG. 6 shows an end-view diagram of a rotor for a wound-field synchronous machine in accordance with the present disclosure;

FIG. 7 shows an end-view diagram of a rotor for a wound-field synchronous machine in accordance with the present disclosure;

FIG. 8 shows an end-view diagram of a rotor for a wound-field synchronous machine in accordance with the present disclosure;

FIG. 9 shows an end-view diagram of a rotor for a wound-field synchronous machine in accordance with the present disclosure;

FIG. 10 shows an end-view diagram of a rotor for a wound-field synchronous machine in accordance with the present disclosure;

FIG. 11 shows an end-view of a rotor for a wound-field synchronous machine including a transformer winding in accordance with the present disclosure;

FIG. 12 shows an end-view of a rotor for a wound-field synchronous machine including a transformer winding in accordance with the present disclosure;

FIG. 13 shows an end-view of a rotor for a wound-field synchronous machine including a transformer winding in accordance with the present disclosure; and

FIG. 14 shows a flow chart of steps in a method of operating an electric machine.

### DETAILED DESCRIPTION

Referring to the drawings, the present invention will be described in detail in view of following embodiments. Example embodiments of a rotor 110, 210, 310, 410, 510 having various different configurations for use in a wound-field synchronous machine (WFSM) are provided.

Advantages of WFSMs include reduced costs when compared to electric machines with permanent magnets, higher system efficiencies resulting from increased power factor, enhanced loss minimization and flux weakening control because of an additional field excitation control variable, and improved safety during inverter faults since the field excitation can be de-energized. WFSMs historically have not been popular in traction applications because the field winding supply assembly (e.g., brushes, slip rings, or rotating transformers) can be large, expensive, prone to deterioration, and add extra losses to the machine. However, emerging technologies such as harmonic, inductive, and capacitive coupling for transferring power to the rotating field windings make WFSMs a noteworthy candidate for future electric vehicle powertrain applications.

The control of the field excitation is the main benefit for the WFSM. During field-weakening (FW) operation of the motor, this field excitation can be controlled rather than injecting additional d-axis current into the stator which does not provide additional torque. The reduced levels of d-axis current increase the power factor in the machine and reduce the electrical stress on the inverter and other components since the required reactive power is minimized. Therefore, the efficiency of the motor and inverter will increase in the field-weakening operating region. Also, wider constant power region can be obtained for operation in electric vehicles. Using a wound field instead of permanent magnets also eliminates the risk of demagnetization due to high rotor temperatures. Further performance improvements may be realized by using permanent magnet (PM) assisted topologies and different field winding configurations on the rotor.

The present disclosure provides different embodiments for placement of the rotor field windings. Placing the field winding in a V-shape or spoke configuration provides an enhanced utilization of the rotor core and can lead to a significant increase in the power density of the machine. The alternative WFSM configurations can also be designed to produce reluctance torque. It can also be designed with an outer rotor to provide more space for field windings. Having the field winding in a V-shaped configuration only requires half the number of conductors in each coil since two coils contribute to the production of one pole. Each field winding may require insulation, liners, and separators.

When compared with permanent magnet synchronous machines (PMSMs), wound-field synchronous machines (WFSMs) provide a number of advantages. The advantages of WFSMs include:
WFSMs can provide a wider constant power region.
WFSMs have increased efficiency in the field weakening (FW) region since d-axis current is not required to weaken the permanent magnet (PM) flux-linkage (increased power factor). This additional d-axis current lowers the power factor of the machine and causes increased copper losses in the motor and conduction losses in the inverter.
Control of the field excitation provides opportunities to optimize field weakening and loss minimization across the drive-cycle.
WFSMs do not require expensive PM material.
WFSMs do not have a fixed flux level in the rotor, which increases safety during inverter faults.
WFSMs may provide increased reliability by reducing or eliminating risks of demagnetizing permanent magnets (PMs), particularly in WFSMs without PMs.

Traditional WFSMs have had some disadvantages when compared with PMSMs. The disadvantages of WFSMs include:
It can be difficult to transfer power to a rotating field winding. WFSMs previously incorporated three methods: slip rings, brushes, and rotating transformers. Recently, three other brushless methods have been developed: harmonic, inductive, and capacitive power transfer.
Extra components, controls, and circuitry may be needed to provide for field excitation.
Copper losses generated by the field windings on the rotor may necessitate rotor cooling.

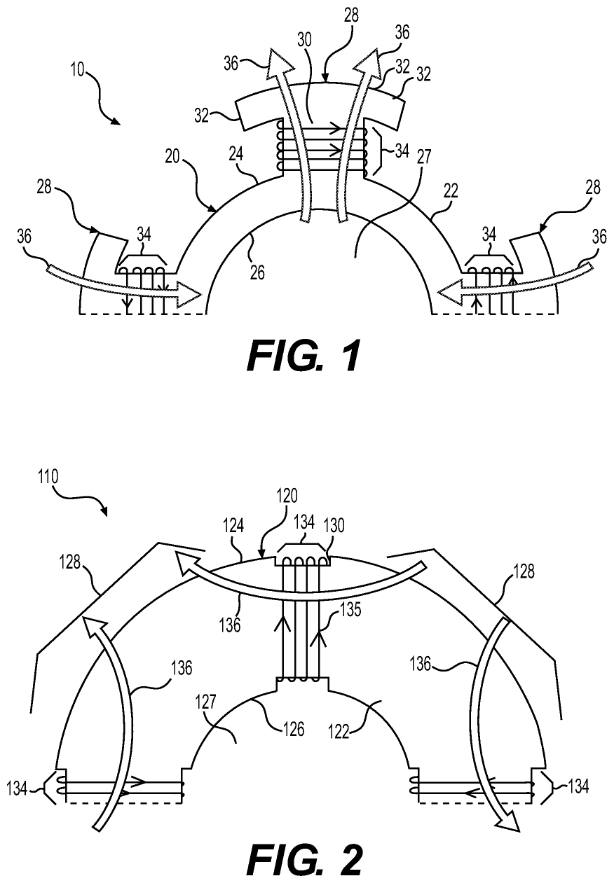

FIG. 1 shows an end-view of a first rotor 10 for a conventional salient pole wound-field synchronous machine. Specifically, the first rotor 10 is a salient pole type rotor having a core 20 of electrical steel that includes a base 22 having a ring-shaped cross-section between an outside surface 24 and an inside surface 26 defining a bore 27 and extending annularly about an axis of rotation of the first rotor 10. The first rotor 10 also includes a plurality of poles 28 extending radially outwardly from the base 22 of the core 20 at regular angular intervals thereabout. The first rotor 10 shown in FIG. 1 has four poles 28, each spaced apart by 90-degrees. However, the first rotor 10 may include any number of the poles 28. Each of the poles 28 has a T-shape cross-section, with a body 30 extending radially outwardly from the base 22 and a head 32 extending perpendicularly to the body 30 and spaced away from the base 22. The head 32 defines a top surface 33 spaced apart from and facing away from the base 22.

A field winding 34 of conductive wire wraps around the body 30 of each of the poles for carrying an electrical current and thus generating a magnetic field 36 through each of the pole 28. The field windings 34 in adjacent ones of the poles 28 are configured to carry currents in alternating directions, thereby causing adjacent ones of the poles 28 to have magnetic fields 36 in opposite directions. The first rotor 10 shown in FIG. 1 may be used as an internal rotor motor, circumferentially surrounded by a stator (not shown) that remains stationary as the first rotor 10 rotates. Alternatively, the first rotor 10 may be configured for use in an external rotor motor, with the first rotor 10 surrounding the stator. In some embodiments, such as for external rotor configurations, the poles 28 may extend radially inwardly from the base 22 of the core 20.

FIG. 2 shows an end-view of a second rotor 110 for a wound-field synchronous machine in accordance with some embodiments of the present disclosure. The second rotor 110 has a core 120 of electrical steel that includes a base 122 having a ring-shaped cross-section between an outside surface 124 and an inside surface 126 defining a bore 127 and extending annularly about an axis of rotation of the second rotor 110. The second rotor 110 also includes a plurality of poles 128 at regular angular intervals thereabout, each of the poles 128 being a region of the base 122 producing a corresponding magnetic field 136. A plurality of field windings 134 are spaced apart from one another at regular angular intervals and each extending around the base 122 of the core 120, adjacent the outside surface 124 and through the bore 127. The second rotor 110 shown in FIG. 2 may be called a spoke-type configuration, with each of the field windings 134 extending in a radial direction, like spokes of a wheel.

In some embodiments, and as shown in FIG. 2, the base 122 of the core 120 defines a plurality of slots 130, with each of the slots 130 extending thereabout and within each of the outer surface 124 and the inner surface 126 and receiving a corresponding one of the plurality of field windings 134. In some embodiments, each of the slots 130 has a generally rectangular cross-section. However, one or more of the slots 130 may have a different shape. The slots 130 are disposed at regular angular intervals around the base 122. There are four slots 130, each spaced apart by 90-degrees in the example second rotor 110 shown in FIG. 2. However, the second rotor 110 may include any number of slots 126.

In the second rotor 110 shown in FIG. 2, the field windings 134 are each configured to conduct current in a radial direction around the base 122 of the core 120 to induce a magnetic field 136 through the core 120 tangentially to the ring-shaped cross-section of the core. In other words, the field windings 134 generate magnetic fields 136 in the base 122, thus defining the poles 128 as regions of the base 122 between adjacent ones of the field windings 134. The magnetic field 136 induced by the current in the field windings 134 extends tangentially to a circle within and coaxially with the ring-shaped core 120. The field windings 134 in adjacent ones of the slots 130 are configured to carry currents in alternating directions, thereby causing each of the poles 128 to have a common magnetic field 136 that is generated by a combination of the field windings 134 in each of the two slots 130 adjacent thereto. Likewise, the magnetic fields 136 in each of the slots 130 has a polarity opposite to the magnetic field 136 in the next adjacent ones of the poles 124. The magnetic fields 136 are configured to interact with fields from a stator (not shown) to produce torque.

In some embodiments, and as shown in FIG. 2, each of the field windings 134 comprises a conductor 135, such as a copper wire, extending substantially radially relative to an axis of rotation of the second rotor 110 or extending substantially parallel to a radius relative to the axis of rotation. In other words, the conductors 135 extend for a substantial length (e.g., substantially larger than a cross-section of the conductor) in a radial direction, or parallel to a radius.

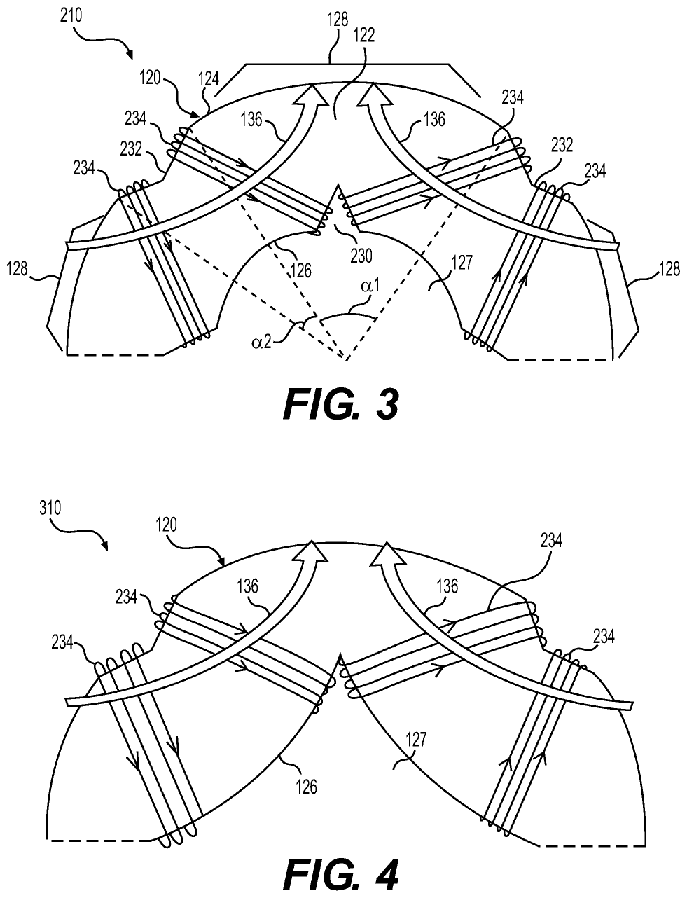

FIG. 3 shows an end-view of a third rotor 210 for a wound-field synchronous machine in accordance with some embodiments of the present disclosure. The third rotor 210 of FIG. 3 is similar to the second rotor 110 of FIG. 2, with some modifications. Specifically, the third rotor 210 has a core 120 of electrical steel that includes a base 122 having a ring-shaped cross-section between an outside surface 124 and an inside surface 126 defining a bore 127 and extending annularly about an axis of rotation of the third rotor 210. The third rotor 210 also includes a plurality of poles 128 at regular angular intervals thereabout, each of the poles 128 being a region of the base 122 producing a corresponding magnetic field 136. The example third rotor 210 shown in FIG. 3 has four poles 128, each spaced apart by 90-degrees. However, the third rotor 210 may include any number of poles 128. A plurality of field windings 134 are spaced apart from one another at regular angular intervals and each extending around the base 122 of the core 120, adjacent the outside surface 124 and through the bore 127. The inside surface 126 of the base 122 defines a plurality of interior recesses 230 spaced apart from one another at a regular angular intervals. In the example third rotor 210 shown in FIG. 3, the interior recesses 230 are formed as notches having a V-shaped cross-section, however, the interior recesses 230 may have different shapes or configurations. An external coil retainer 232 is disposed upon the outside surface 124 of the base 122. The external coil retainer 232 is circumferentially separated from a corresponding one of the interior recesses 230.

In some embodiments, and as shown in FIG. 3, each of the external coil retainers 232 are circumferentially offset midway between two adjacent ones of the interior recesses 230. A field winding 234 extends radially and circumferentially from one of the interior recesses 230 around the base 122 of the core 120 and to a corresponding one of the external coil retainers 232. In some embodiments, and as shown in FIG. 3, each of the external coil retainers 232 is formed as a groove having a V-shaped cross-section in the outside surface 124 of the base 122. In other embodiments, one or more of the external coil retainers 232 may be formed as a protrusion extending radially outwardly from the outside surface 124 of the base 122. The external coil retainers 232 may take other forms, such as portions or regions of a material, such as a potting material, that hardens to secure the field winding 134 at a predetermined position upon the outside surface 124 of the base 122.

The V-shaped configuration of the field windings 134 may use less conductors when compared with conventional designs, since two coils contribute to the induced magnetic field 136 of each pole 128. For example, each field winding 134 may use half the number of turns when compared with a conventional design.

As shown in FIG. 3, the base 122 defines a first angle α1 between adjacent ones of the external coil retainers 232, and each of the external coil retainers 232 defines a second angle α2, with the field windings 134 disposed within the second angle α2 adjacent to the outside surface 124 of the base 122. The first angle α1 is substantially larger than the second angle α2.

In some embodiments, and as shown in FIG. 3, the inside surface 126 of the base 122 has a generally circular cross-section. FIG. 4 shows a fourth rotor 310 having a similar configuration to the third rotor 210 of FIG. 3. In some embodiments, and as shown in FIG. 4, the inside surface 126 of the base 122 defines a convex curve extending radially inwardly between adjacent ones of the plurality of interior recesses 230, thus providing the bore 127 with a star-shaped cross-section. The inside surface 126 of the base 122 may define other shapes. For example, inside surface 126 of the base 122 may define straight lines between adjacent ones of the plurality of interior recesses 230, thus providing the bore 127 with a cross-sectional shape of a regular polyhedron, such as a hexagon or an octagon.

The example embodiments of FIGS. 3-4 each include the field windings 234 arranged in a V-shape. The field windings 234 are wrapped axially around the rotor core 120 where two field windings 234 contribute to the production of a single pole 128. The small arrows on the field windings 234 indicate the direction of current to form the poles 128 of the machine. The shape of the rotor core 120 can be configured as shown in FIGS. 2 and 3 to decrease saturation and torque ripple as well as enhancing the mechanical integrity of the rotor structure 120 and/or field windings 234.

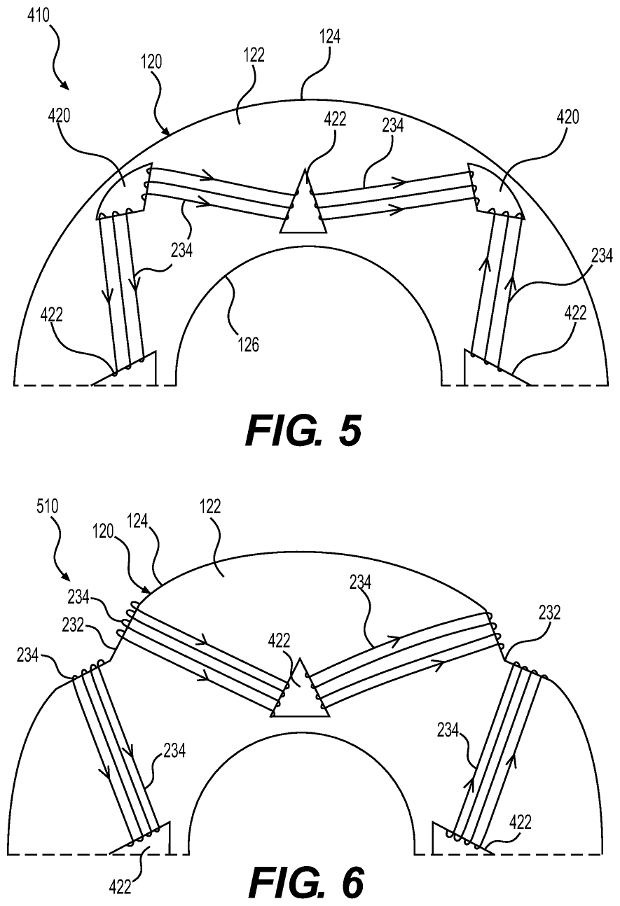

FIG. 5 shows an end-view diagram of a fifth rotor 410 for a wound-field synchronous machine in accordance with some embodiments of the present disclosure. The fifth rotor 410 is similar in construction to the third rotor 210 of FIG. 3, but with the field windings 234 not contacting either of the outside surface 124 or the inside surface 126 of the base 122 of the core 120. Instead, the base 122 of the fifth rotor 410 defines a plurality of first holes 420 extending therethrough at regular circumferential intervals and disposed radially inwardly from the outside surface 124. Each of the first holes 420 has a wedge shape, with a point facing radially inwardly, but the first holes 420 may have other shapes, such as, for example, a triangle, a square, or a circle. The base 122 of the fifth rotor 410 also defines a plurality of second holes 422 extending therethrough at regular circumferential intervals and disposed radially inwardly from the first holes 420. Each of the second holes 422 has a triangular shape, with a point facing radially outwardly, but the second holes 422 may have other shapes, such as, for example, a wedge, a square, or a circle. Each of the second holes 422 is disposed circumferentially mid-way between two corresponding ones of the first holes 420. The field windings 234 extend radially and circumferentially between each of the first holes 420 and next circumferentially adjacent ones of the second holes 422. Unless explicitly defined otherwise, the term “regular circumferential intervals” is intended to mean a same circumferential arc length between each of any two circumferentially adjacent structures.

FIG. 6 shows an end-view diagram of a sixth rotor 510 for a wound-field synchronous machine in accordance with some embodiments of the present disclosure. The sixth rotor 510 is similar in construction to the third rotor 210 of FIG. 3, but with the field windings 234 not contacting the inside surface 126 of the base 122 of the core 120. The sixth rotor 510 is also similar to the fifth rotor 410 of FIG. 5 in that they both include a plurality of regularly spaced second holes 422. Each of the second holes 422 of the sixth rotor 510 is disposed circumferentially mid-way between two corresponding ones of the external coil retainers 232, and the field windings 234 each extend radially and circumferentially between each of the second holes 422 and next circumferentially adjacent ones of the external coil retainers 232.

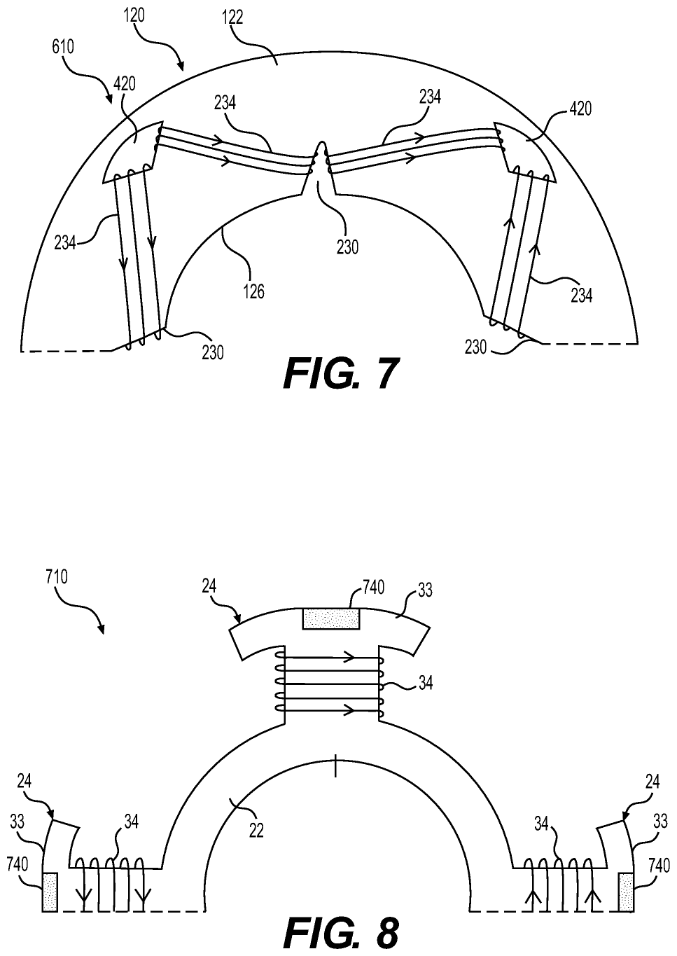

FIG. 7 shows an end-view diagram of a seventh rotor 610 for a wound-field synchronous machine in accordance with some embodiments of the present disclosure. The seventh rotor 610 is similar in construction to the third rotor 210 of FIG. 3, but with the field windings 234 not contacting the outside surface 124 of the base 122 of the core 120. The seventh rotor 610 is also similar to the fifth rotor 410 of FIG. 5 in that they both include a plurality of regularly spaced first holes 420. Each of the first holes 420 of the seventh rotor 610 is disposed circumferentially mid-way between two corresponding interior recesses 230 in the inside surface 126 of the base 122, and the field windings 234 each extend radially and circumferentially between each of the first holes 420 and next circumferentially adjacent ones of the interior recesses 230.

The rotors 210, 310, 410, 510, 610 of FIGS. 3-7 all function similarly to the second rotor 110 of FIG. 2, with the field windings 234 each configured to conduct current in a radial direction around at least a portion the base 122 of the core 120 to induce a magnetic field 136 through the core 120 tangentially to the ring-shaped cross-section of the core. This results in current through the field windings 234 generating magnetic fields 136 in the base 122, thus defining the poles 128 as regions of the base 122 between adjacent ones of the field windings 134. The magnetic field 136 induced by the current in the field windings 234 extends tangentially to a circle within and coaxially with the ring-shaped core 120. As shown in FIG. 3, the field windings 234 are configured to carry currents in alternating directions, thereby causing each of the poles 128 to have a common magnetic field 136 that is generated by a combination of the field windings 134 in each of the two slots 130 adjacent thereto. The poles 128 have alternating polarity around a circumference of the core 120.

FIGS. 8-10 show example configurations for permanent magnet (PM) assisted WFSMs. FIG. 8 shows an end-view diagram of an eighth rotor 710 for a wound-field synchronous machine in accordance with some embodiments of the present disclosure. The an eighth rotor 710 of FIG. 8 is similar to the conventional salient pole first rotor 10 of FIG. 1, but with the addition of a permanent magnet 440 disposed within each of the poles 24. More specifically, FIG. 8 shows a particular embodiment of an eighth rotor 710 in which the permanent magnet 440 is recessed within a top surface 33 of each of the poles 24 opposite from the base 22. In some embodiments, and as shown in FIG. 8, the an eighth rotor 710 each of the poles 28 extends radially outwardly from the base 22 away from an axis of rotation of the eighth rotor 710. In some alternative embodiments, such as, for example in an external rotor electric machine, each of the poles 28 extends radially inwardly from the base 22 toward the axis of rotation of the eighth rotor 710.

In other embodiments, the permanent magnet 440 may have a different arrangement within the poles 24. For example, a rotor 110, 210, 310 having a design as shown in FIGS. 2-4 may be provided with one or more permanent magnet 440 within each of the poles.

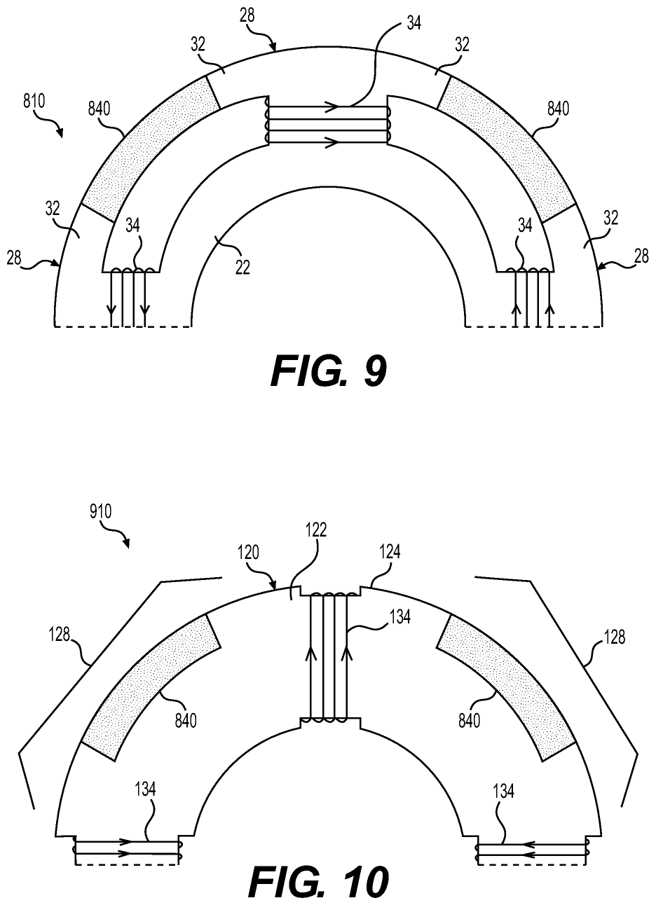

FIG. 9 shows an end-view diagram of a ninth rotor 810 for a wound-field synchronous machine in accordance with some embodiments of the present disclosure. The sixth rotor 510 of FIG. 9 is similar to the eighth rotor 710 of FIG. 8, except each of the permanent magnets 540 is disposed between two adjacent ones of the poles 28. More specifically, each of the permanent magnets 540 extend circumferentially between a head 32 of the pole 28 and a head 32 of the next adjacent one of poles 28, with the heads 32 of each of the plurality of poles 28 radially spaced apart from the base 22 of the core 20. In some embodiments, and as shown in FIG. 9, the each of the poles 28, extends radially outwardly from the base 22 away from an axis of rotation. In some alternative embodiments, such as, for example in an external rotor electric machine, each of the poles 28 extends radially inwardly from the base 22 toward the axis of rotation of the rotor 710.

FIG. 10 shows an end-view diagram of a tenth rotor 910 for a wound-field synchronous machine in accordance with some embodiments of the present disclosure. The tenth rotor 910 of FIG. 10 is similar to the second rotor 110 of FIG. 2, except for the addition of a permanent magnet 840 in each of the poles 128. In some embodiments, and as shown in FIG. 10, each of the permanent magnets 840 is shaped as an arcuate segment of an annular ring that is recessed within the base 122 of the core 120 and flush with the outside surface 124 of the base 122. However, the permanent magnets 840 may have a different shape, orientation, and/or configuration.

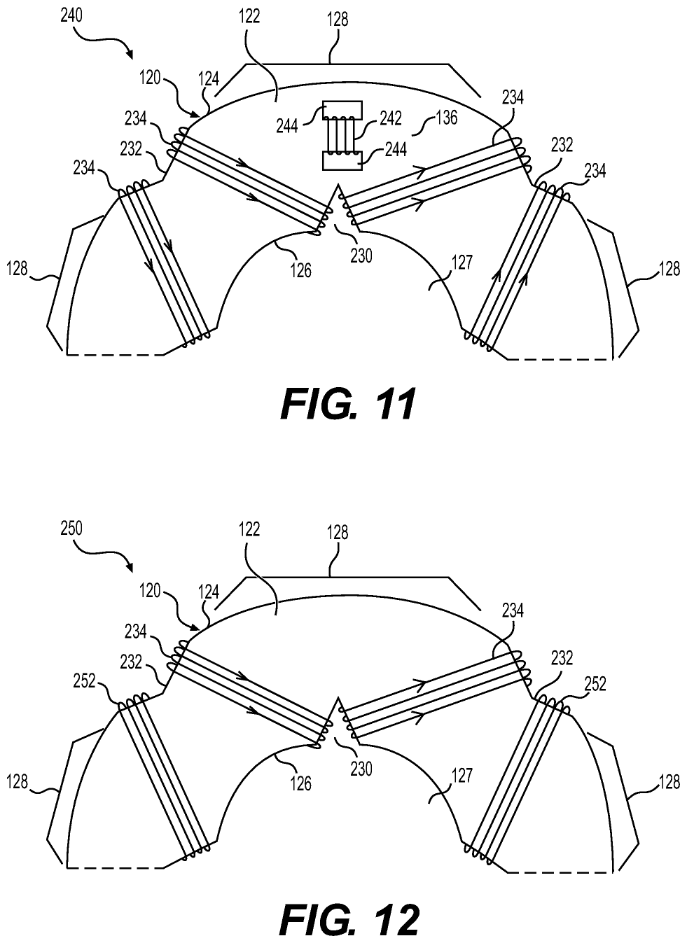

FIGS. 11-13 show rotors 240, 250, 260 each with a transformer winding 242, 252, 262 in addition to the field windings 134, 234, described above. The transformer winding 242, 252, 262 may be one of a plurality of transformer windings 242, 252, 262, which may be equal in number to the number of poles 128. The transformer windings 242, 252, 262 and field windings 134 can be configured differently than as shown in the figures. In addition to the fundamental current fed to the stator windings, harmonic current is also fed to the stator windings. An AC voltage is induced in the transformer windings 242, 252, 262 due to a harmonic current excitation in the stator windings. The AC voltage output of the transformer windings 242, 252, 262 may be rectified to a DC power, which may then be supplied to the field windings 134, 234. For example, a rotating rectifier located on the shaft of the WFSM (not shown in the FIGS) may be used to rectify the AC voltage output of the transformer windings 242, 252, 262. Such a rotating rectifier may be built on a circular PCB spinning along with the rotor. The DC output of the rectifier may be fed to the field windings 134, 234 of the rotor. Controlling the harmonic current magnitude in the stator can control the DC current magnitude in the field winding. The transformer windings 242, 252, 262 could be configured as 1-phase or 3-phase windings. An electric machine incorporating such a rotor 240, 250, 260 could be called a self-excited or harmonic excited WFSM.

FIG. 11 shows an end-view diagram of an eleventh rotor 240 for a wound-field synchronous machine. The eleventh rotor 240 has a similar configuration to the third rotor 210 of FIG. 3, with the field windings 234 extending radially and circumferentially around the base 122 of the core 120 in a V-shaped configuration. FIG. 11 also includes a first transformer winding 242 disposed within one of the poles 128. The first transformer winding 242 shown in FIG. 11 is disposed around the core 120 of the rotor 240, extending in a generally radial direction between two third holes 244 in the core 120 of the rotor 240. This is merely one example, and the first transformer winding 242 may be wound around all or part of the core 120. For example, the first transformer winding 242 may be disposed around either or both of the outside surface 124 and/or the inside surface 126. In some embodiments, the first transformer winding 242 may be disposed within an interior recess 230 in the inside surface 126. In some embodiments, the first transformer winding 242 may be disposed within an external coil retainer 232, such as a rectangular or V-shaped notch in the outside surface 124. In some embodiments, the first transformer winding 242 may be disposed within a same interior recess 230 and/or external coil retainer 232 with one or more of the field windings 34, 134, 234.

FIG. 12 shows an end-view diagram of an twelfth rotor 250 for a wound-field synchronous machine. The twelfth rotor 250 has a similar configuration to the third rotor 210 of FIG. 3, with the field windings 234 extending radially and circumferentially around the base 122 of the core 120 in a V-shaped configuration. FIG. 12 also includes a second transformer winding 252 disposed within one of the poles 128. The second transformer winding 252 shown in FIG. 12 is disposed around the core 120 of the rotor 240, wound radially and circumferentially between an external coil retainer 232, such as a V-shaped notch, and an interior recess 230 in the inside surface 126. The second transformer winding 252 may be arranged in an alternating pattern with the field windings 234, as shown in FIG. 12. This is merely one example, and the second transformer winding 252 may be wound around all or part of the core 120. For example, the second transformer winding 252 may be disposed around either or both of the outside surface 124 and/or the inside surface 126.

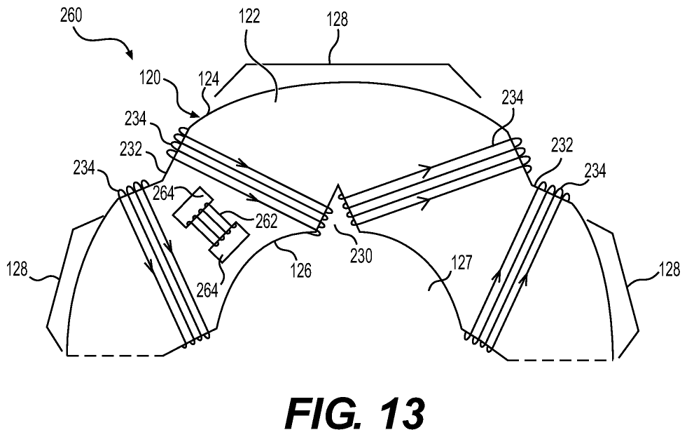

FIG. 13 shows an end-view diagram of an thirteenth rotor 260 for a wound-field synchronous machine. The thirteenth rotor 260 has a similar configuration to the third rotor 210 of FIG. 3, with the field windings 234 extending radially and circumferentially around the base 122 of the core 120 in a V-shaped configuration. FIG. 13 also includes a third transformer winding 262 disposed between two adjacent ones of the poles 128. The third transformer winding 262 shown in FIG. 13 is disposed around the core 120 of the rotor 240, extending in a generally radial direction between two fourth holes 264 in the core 120 of the rotor 240. This is merely one example, and the third transformer winding 262 may be wound around all or part of the core 120. For example, the third transformer winding 262 may be disposed around either or both of the outside surface 124 and/or the inside surface 126. In some embodiments, the third transformer winding 262 may be disposed within an interior recess 230 in the inside surface 126. In some embodiments, the third transformer winding 262 may be disposed within an external coil retainer 232, such as a rectangular or V-shaped notch in the outside surface 124. In some embodiments, the first transformer winding 242 may be disposed within a same interior recess 230 and/or external coil retainer 232 with one or more of the field windings 34, 134, 234.

The transformer windings 242, 252, 262 are configured to generate an induced voltage for supplying power to the field windings 34, 134, 234. For example, one or more of the transformer windings 242, 252, 262 may be connected as an input to a rectifier, which may produce a DC output to be fed to the field windings 134, 234, as described above.

The proposed V-shaped field windings 34, 134, 234 in the rotor 240, 250, 260 enable manufacturing feasibility and mechanical strength to the transformer winding 242, 252, 262 and core 120. The machine can have ‘n’ number of phases, ‘k’ number of slots and ‘m’ number of poles. Number of the harmonic component and magnitude depends on n, k, m and winding type.

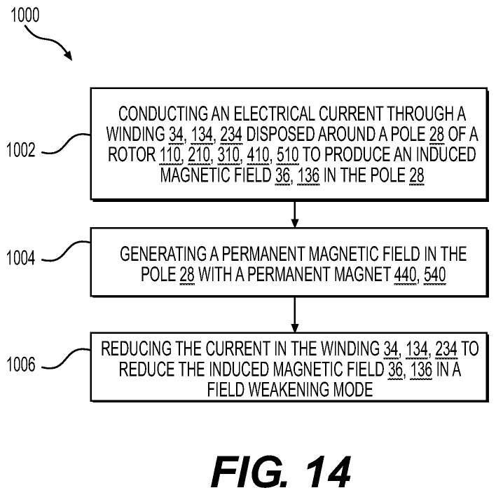

A method 1000 of operating an electric machine is shown in the flow chart of FIG. 14. The method 1000 includes conducting an electrical current through a field winding 34, 134, 234 disposed around a pole 28 of a rotor 110, 210, 310, 410, 510 to produce an induced magnetic field 36, 136 in the pole 28 at step 1002. This induced magnetic field 36, 136 can be controlled or modified as a field excitation control variable. The electrical current may be transmitted to the rotor 110, 210, 310, 410, 510 in any one of several different ways. For example, the electric machine (i.e., the field windings 34, 134, 234) can be self-excited or separately excited. The excitation to the rotor 110, 210, 310, 410, 510 can come from the stator or from a power supply assembly on the rotor. For example, in a separately excited configuration, the power supply to the rotor 110, 210, 310, 410, 510 can come from a capacitive coupling, an inductive coupling, brushes, a slip ring arrangement, etc. In case of self-excitation, the rotor 110, 210, 310, 410, 510 will have a field coil and transformer coil. The transformer coil links with the stator excitation and produces an AC supply which will be converter to DC supply to feed the field winding 34, 134, 234. The conversion will take place using a rectifier that could be mounted on the rotor 110, 210, 310, 410, 510. The transformer coils and field windings 34, 134, 234 could be placed in different ways in the rotor 110, 210, 310, 410, 510. The transformer coils could be adjacent to the field windings 34, 134, 234 in different rotor poles. Alternatively, the transformer coil could be wound on the same rotor pole that the field winding 34, 134, 234 is wound on.

In some embodiments, the method 1000 also includes generating a permanent magnetic field in the pole 28 with a permanent magnet 440, 540 at step 1004. In some embodiments, the induced magnetic field 36, 136 is configured to additively supplement the permanent magnetic field in the pole 28.

In some embodiments, the method 1000 also includes reducing the current in the field winding 34, 134, 234 to reduce the induced magnetic field 36, 136 in a field-weakening mode at step 1006.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A rotor for an electric machine comprising:
a core having a base with a ring-shaped cross-section extending between an outside surface and an inside surface defining a bore;
a plurality of field windings spaced apart from one another at regular angular intervals and each configured to conduct current in a radial direction around the base of the core to induce a magnetic field through the core tangentially to the ring-shaped cross-section.

2. The rotor of claim 1, wherein the corresponding one of the plurality of field windings extends around the core adjacent the outside surface and through the bore.

3. The rotor of claim 1, further comprising the base of the core defining a plurality of slots, with each of the slots receiving a corresponding one of the plurality of field windings.

4. The rotor of claim 1, further comprising a transformer winding disposed around the core of the rotor and configured to generate an induced voltage for supplying power to the field windings; and
wherein the plurality of field windings each extend radially and circumferentially around the base of the core.

5. A rotor for an electric machine comprising:
a core having a base with a ring-shaped cross-section extending between an outside surface and an inside surface defining a bore;
the inside surface of the base defining an interior recesses;
an external coil retainer disposed upon the outside surface of the base, the external coil retainer circumferentially separated from the interior recess a field winding extending radially and circumferentially from the interior recess around the base of the core and to the external coil retainer;
wherein the interior recess is one of a plurality of interior recesses spaced apart from one another at a regular angular interval.

6. The rotor of claim 5, wherein the external coil retainer is formed as a groove having a V-shaped cross-section in the outside surface of the base.

7. The rotor of claim 5, wherein the inside surface of the base defines a generally circular cross-section.

8. A rotor for an electric machine comprising:
a core having a base and a pole extending radially therefrom;
a field winding extending about the pole for generating an induced magnetic field therein; and
a permanent magnet disposed within the pole.

9. The rotor of claim 8, wherein the permanent magnet is recessed within a top surface of the pole opposite of the base.

10. The rotor of claim 8, wherein the pole is one of a plurality of poles; and
wherein each pole of the plurality of poles extends either radially outwardly from the base away from an axis of rotation of the rotor, or radially inwardly from the base toward an axis of rotation of the rotor.

11. A rotor for an electric machine comprising:
a core having a base and a pole extending radially therefrom;
a field winding extending about the pole for generating an induced magnetic field therein;
wherein the pole is one of a plurality of poles spaced apart from one another at regular angular intervals;
a permanent magnet disposed between the pole and a next adjacent one of the plurality of poles.

12. The rotor of claim 11, wherein the pole is one of a plurality of poles; and
wherein each pole of the plurality of poles extends radially outwardly from the base away from an axis of rotation of the rotor, or radially inwardly from the base toward an axis of rotation of the rotor.

13. The rotor of claim 11, wherein the permanent magnet extends circumferentially between a head of the pole and a head of the next adjacent one of poles, with the heads of each of the plurality of poles radially spaced apart from the base of the core.

14. A method of operating an electric machine, comprising:
conducting an electrical current through a field winding disposed around a pole to produce an induced magnetic field in the pole; and
generating a permanent magnetic field in the pole with a permanent magnet.

15. The method of operating an electric machine of claim 14, wherein the induced magnetic field is configured to additively supplement the permanent magnetic field in the pole.

16. The method of operating an electric machine of claim 14 further comprising: reducing the current in the field winding to reduce the induced magnetic field in a field-weakening mode.

17. The rotor of claim 1, wherein each field winding of the plurality of field windings comprises a conductor extending substantially radially relative to an axis of rotation of the rotor or extending substantially parallel to a radius relative to the axis of rotation.

18. The rotor of claim 3, wherein each slot of the plurality of slots has a generally rectangular cross-section.

19. The rotor of claim 5, wherein the external coil retainer is formed as a protrusion extending radially outwardly from the outside surface of the base.

20. The rotor of claim 5, wherein the inside surface of the base defines a convex curve extending radially inwardly between adjacent ones of the plurality of interior recesses.
